(19) United States
(12) Patent Application Publication
(10) Pub. No.: US 2026/0170550 A1
(43) Pub. Date: Jun. 18, 2026

(54) METHOD AND SYSTEM FOR SHARING PRODUCT INFORMATION BASED ON ENTERPRISE PROCUREMENT

(71) Applicant: SEKORM ESERVICE CO., LTD., Shenzhen City (CN)

(72) Inventors: QING XIAO, Shenzhen City (CN); FANG LI, Shenzhen City (CN); SIHONG DUAN, Shenzhen City (CN)

(73) Assignee: SEKORM ESERVICE CO., LTD., Shenzhen City (CN)

(21) Appl. No.: 19/533,262

(22) Filed: Feb. 8, 2026

Related U.S. Application Data
(63) Continuation of application No. PCT/CN2024/111251, filed on Aug. 9, 2024.

(30) Foreign Application Priority Data
Aug. 11, 2023 (CN) 202311014631.4

(51) Int. Cl. G06Q 30/0601

(52) U.S. Cl. CPC G06Q 30/0637; G06Q 30/0627

(57) ABSTRACT

The present invention relates to a method and a system for sharing product information based on enterprise procurement, comprising the following steps: a client receives product information and initiates an enterprise procurement service based on the product information; the client generates a procurement list based on procurement information and the product information; the client sends the procurement list to a terminal; the terminal receives the procurement list and obtains enterprise procurement information based on the procurement list; the terminal sends a procurement order to a server based on the enterprise procurement information; the server receives the procurement order and returns an order confirmation message to the client based on the procurement order. In the present invention, it can avoid the issue of procurement results failing to meet engineering requirements due to traditional procurement processes, thereby ensuring the progress and quality of product development.

### CROSS-REFERENCE TO RELATED APPLICATIONS

The present application is a continuation of PCT Application No. PCT/CN2024/111251 filed on Aug. 9, 2024, which claims priority to a Chinese Patent Application No. 202311014631.4 filed on Aug. 11, 2023, the entire contents of which are incorporated herein by reference.

### TECHNICAL FIELD

The present invention relates to the technical field of e-commerce, and more specifically, to a method and a system for sharing product information based on enterprise procurement.

### DESCRIPTION OF RELATED ART

In traditional enterprise settings, engineers are responsible for product design and development based on product planning and requirements. They then submit procurement requests to the procurement department through the company's internal OA (Office Automation) system. Due to differences in professional backgrounds and job functions between R&D engineers and procurement personnel, information asymmetry and communication barriers often arise during the procurement process. This results in procurement outcomes failing to meet engineering requirements, ultimately affecting product development timelines and quality.

### BRIEF SUMMARY OF THE INVENTION

The technical problem to be solved by the present invention is to provide a method and a system for sharing product information based on enterprise procurement.

The technical solution adopted by the present invention to solve the technical problem is to construct a method for sharing product information based on enterprise procurement, comprising the following steps:
A client receives product information of a product to be procured input by a user and initiates an enterprise procurement service based on the product information;
The client receives procurement information input by a user and generates a procurement list based on the procurement information and the product information;
The client sends the procurement list to a terminal;
The terminal receives the procurement list and obtains enterprise procurement information based on the procurement list;
The terminal sends a procurement order to a server based on the enterprise procurement information;
The server receives the procurement order and returns an order confirmation message to the client based on the procurement order.

In the method for sharing product information based on enterprise procurement according to the present invention, the product information comprises: the name of the product to be procured and the quantity of the product to be procured;
The procurement information comprises: information of the procurement officer and information of the engineer;
The information of the procurement officer comprises: the name and contact details of the procurement officer;
The information of the engineer comprises: the name of the company where the engineer works, the department of the engineer, the name of the engineer, and the contact details of the engineer.

In the method for sharing product information based on enterprise procurement according to the present invention, the step of the client receives the procurement information input by a user and generates the procurement list based on the procurement information and the product information comprises:
The client receives the information of the procurement officer and the information of the engineer input by a user;
Adding the information of the procurement officer and the information of the engineer to the product information to generate the procurement list.

In the method for sharing product information based on enterprise procurement according to the present invention, before the client sends the procurement list to the terminal, the method further comprises:
The client receives a procurement information confirmation operation instruction input by a user;
The client outputs and displays the procurement list based on the procurement information confirmation operation instruction;
The client determines whether a confirmation instruction input by a user is received;
If yes, the client sends the procurement list to the terminal.

In the method for sharing product information based on enterprise procurement according to the present invention, the method further comprises:
After the client sends the procurement list to the terminal, generating an enterprise procurement service order.

The present invention further provides a system for sharing product information based on enterprise procurement, comprising: a client and a terminal.

The client is configured to: receive product information of a product to be procured input by a user, and initiate an enterprise procurement service based on the product information;
Receive procurement information input by a user, and generate a procurement list based on the procurement information and the product information;
Send the procurement list to a terminal, and display an order confirmation message after receiving the order confirmation message returned by a server;
The terminal is configured to: receive the procurement list and obtain enterprise procurement information based on the procurement list;
Send a procurement order to a server based on the enterprise procurement information.

In the system for sharing product information based on enterprise procurement according to the present invention, the system further comprises: a server;
The server receives the procurement order and returns the order confirmation message to the client based on the procurement order.

In the system for sharing product information based on enterprise procurement according to the present invention, the product information comprises: the name of the product to be procured and the quantity of the product to be procured;
The procurement information comprises: information of the procurement officer and information of the engineer;
The information of the procurement officer comprises: the name and contact details of the procurement officer;
The information of the engineer comprises: the name of the company where the engineer works, the department of the engineer, the name of the engineer, and the contact details of the engineer.

In the system for sharing product information based on enterprise procurement according to the present invention, the client is specifically configured to:
Receive the information of a procurement officer and the information of an engineer input by a user;
Add the information of the procurement officer and the information of the engineer to the product information to generate a procurement list.

In the system for sharing product information based on enterprise procurement according to the present invention the client is further configured to:
Receive a procurement information confirmation operation instruction input by a user;
Output and display the procurement list based on the procurement information confirmation operation instruction;
Determine whether a confirmation instruction input by a user is received;
If yes, send the procurement list to a terminal.

The implementation of the method and system for sharing product information based on enterprise procurement according to the present invention provides the following beneficial effects: The method comprises the following steps: The client receives product information of a product to be procured input by a user and initiates an enterprise procurement service based on the product information; the client generates a procurement list based on the procurement information and the product information; the client sends the procurement list to a terminal; the terminal receives the procurement list and obtains enterprise procurement information based on the procurement list; the terminal sends a procurement order to a server based on the enterprise procurement information; the server receives the procurement order and returns an order confirmation message to the client based on the procurement order. In the present invention, the engineer sends the product information of a product to be procured along with identity information to the procurement officer via the client, enabling the procurement officer to conduct procurement based on the collection information determined by the engineer. This avoids the issue where traditional procurement processes fail to meet engineering requirements, ensuring product development progress and quality.

### BRIEF DESCRIPTION OF THE SEVERAL VIEWS OF THE DRAWINGS

The following further illustrates the present invention with reference to the accompanying drawings and embodiments. In the drawings:

FIG. 1 is a schematic flowchart of the method for sharing product information based on enterprise procurement provided by the present invention;

FIG. 2 is an operational interface diagram of product information selection for enterprise procurement provided by the present invention;

FIG. 3 is a display interface diagram of product information provided by the present invention;

FIG. 4 is an operational interface diagram for engineers to input procurement information provided by the present invention;

FIG. 5 is a schematic diagram of an enterprise procurement service order provided by the present invention;

FIG. 6 is an information display interface diagram of a product demand list provided by the present invention;

FIG. 7 is an information display interface diagram of a procurement list provided by the present invention;

FIG. 8 is an information display interface diagram of enterprise procurement information provided by the present invention;

FIG. 9 and FIG. 10 are information display interface diagrams of order success information provided by the present invention.

### DETAILED DESCRIPTION OF THE INVENTION

The following will clearly and completely describe the technical solutions in the embodiments of the present invention with reference to the accompanying drawings. It is evident that the described embodiments are only a part of the embodiments of the present invention, rather than all of them. Based on the embodiments of the present invention, all other embodiments obtained by those of ordinary skill in the art without creative efforts shall fall within the protection scope of the present invention.

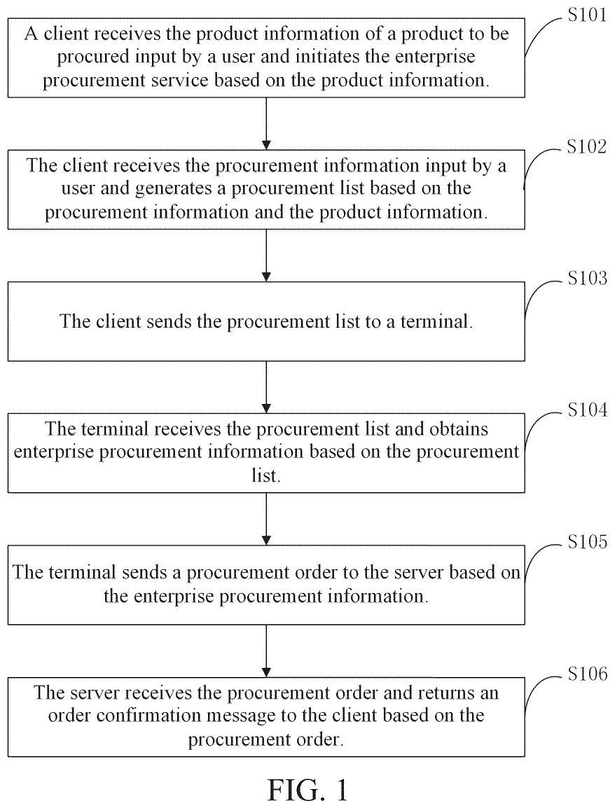

FIG. 1 illustrates the method for sharing product information based on enterprise procurement provided by the present invention. The method specifically comprises the following steps:
Step S101: A client receives the product information of a product to be procured input by a user and initiates the enterprise procurement service based on the product information.

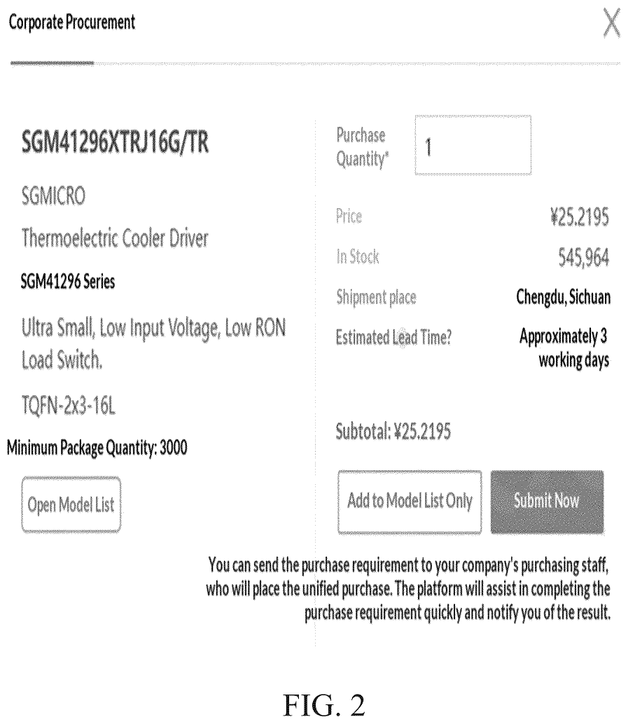

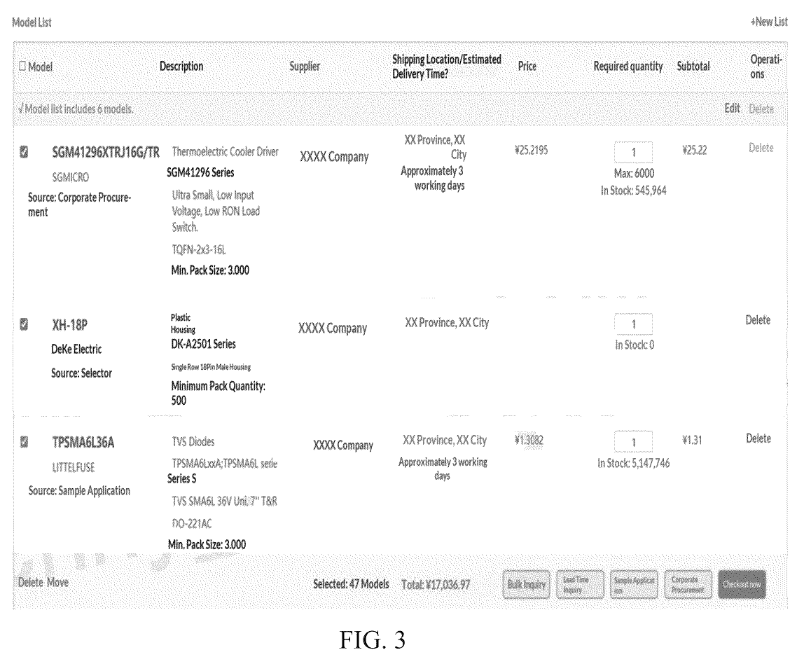

In this embodiment, the client refers to an e-commerce platform. The product information comprises the name of the product to be procured and the quantity of the product to be procured. Specifically, in this embodiment, a user refers to an engineer (where the engineer refers to a research/development engineer) who selects the product to be shared (i.e., the product to be procured) on the product interface of the e-commerce platform, adds the selected product to the model list, specifies the quantity to be procured within the model list, and reselects the product to be procured in the model list. After completing the selection of the product to be procured, the enterprise procurement service can be initiated. Specifically, there is an “Enterprise Procurement” button on the interface of the model list, and the engineer can click this button to initiate the enterprise procurement service. As shown in FIG. 2, which displays the product interface of the e-commerce platform, the engineer can select the product to be procured and their quantities on this interface and add them to the model list. As shown in FIG. 3, the specific quantity of product to be procured can be added in the model list.
Step S102: The client receives the procurement information input by a user and generates a procurement list based on the procurement information and the product information.

In this embodiment, the procurement information comprises: information of a procurement officer and information of an engineer. The information of the procurement officer comprises: the name and contact details of the procurement officer. The contact details of the procurement officer comprise: the procurement officer's phone number, work email, etc. The information of the engineer comprises: the name of the company where the engineer works, the department of the engineer, the name of the engineer, and the contact details of the engineer. The contact details of the engineer comprise: the engineer's phone number and work email, etc.

In this embodiment, the client receives the procurement information input by a user and generates a procurement list based on the procurement information and product information, which comprises: the client receiving the information of the procurement officer and the information of the engineer input by a user; adding the information of the procurement officer and the information of the engineer to the product information to generate the procurement list.

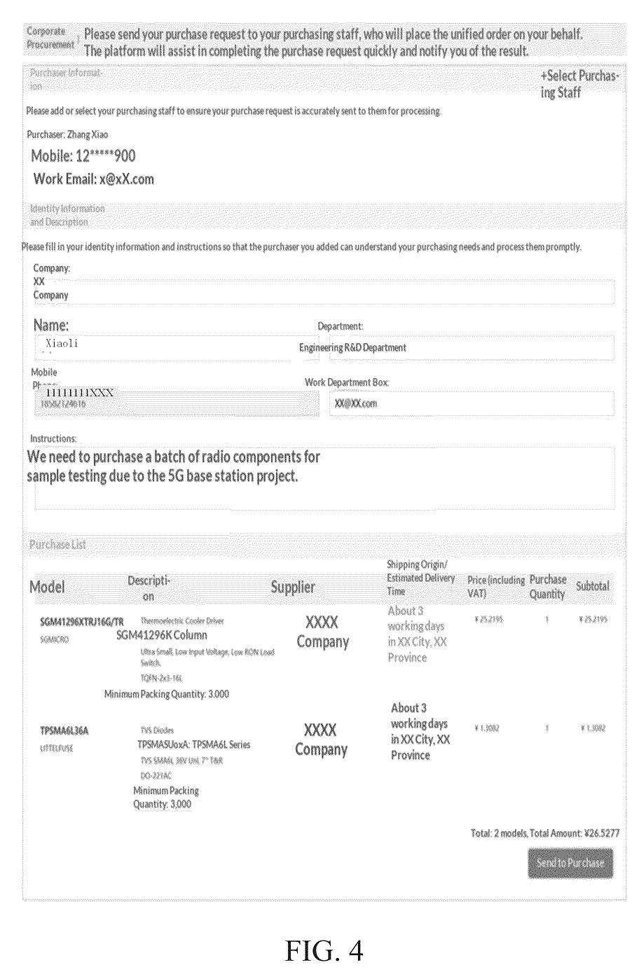

Specifically, after initiating the enterprise procurement service, the e-commerce platform enters the enterprise procurement sharing page. As shown in FIG. 4, on the enterprise procurement sharing page, the engineer can add the information of the procurement officer to be shared, such as name: Xiao Zhang, phone: 12345678900, email: XX@XX.com. By adding the information of the procurement officer to be shared, the e-commerce platform can accurately send the procurement list to the intended procurement officer. Furthermore, in this embodiment, the engineer also needs to supplement and refine their own identity information and procurement description. For example: company: XX Company, name: Xiao Li; department: Engineering R&D Department; phone: 11111111XXX; work email: yy@XX.com; description: Due to the requirements of the 5G base station project, a batch of radio frequency components needs to be procured for sample testing.

Furthermore, in this embodiment, before the client sends the procurement list to the terminal, the process comprises: the client receives a procurement information confirmation operation instruction input by a user; the client outputs and displays the procurement list based on the procurement information confirmation operation instruction; the client determines whether a confirmation instruction input by a user is received; if yes, the client sends the procurement list to the terminal. Specifically, after completing their own identity information and procurement description, the engineer also needs to reconfirm the accuracy of the product demand list's model, delivery date, supplier, and procurement quantity, and only after ensuring the information is complete will the client send the procurement list to the terminal. As shown in FIG. 4, once the engineer confirms everything is correct, they click the “Initiate Procurement” button on the operation interface, and the client sends the procurement list to the terminal.
Step S103: The client sends the procurement list to a terminal.
Step S104: The terminal receives the procurement list and obtains enterprise procurement information based on the procurement list.

In this embodiment, the procurement list comprises: product information of the product to be procured, information of a procurement officer, information of an engineer procurement instructions, etc. Therefore, the enterprise procurement information can be obtained from the received procurement list. The enterprise procurement information comprises the product information of the product to be procured, product demand lists, information of a procurement officer, information of an engineer, procurement instructions, etc.

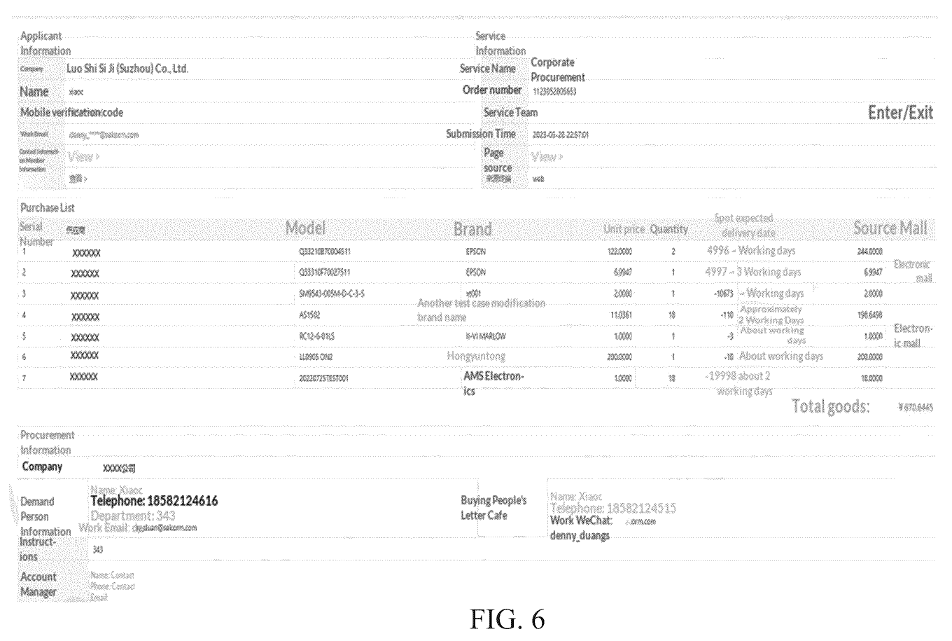

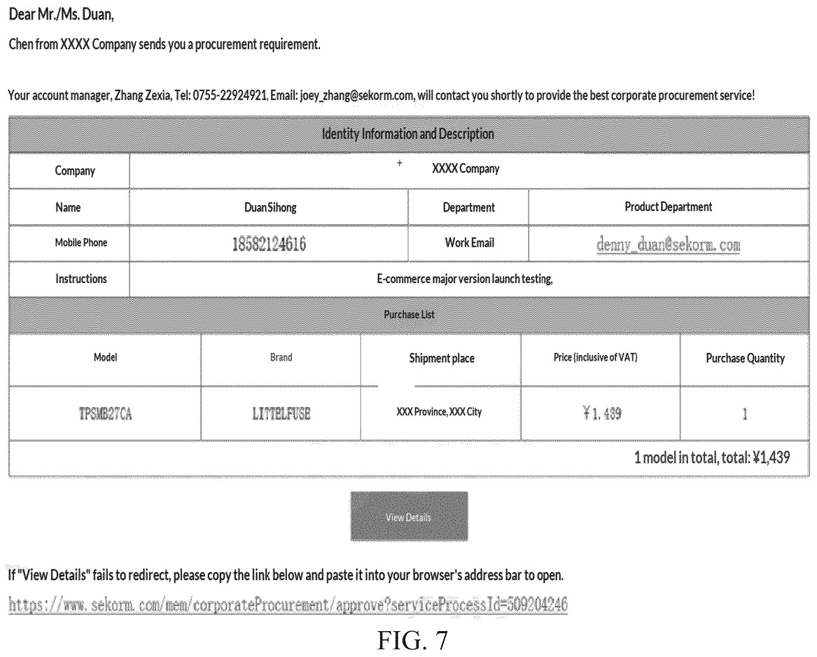

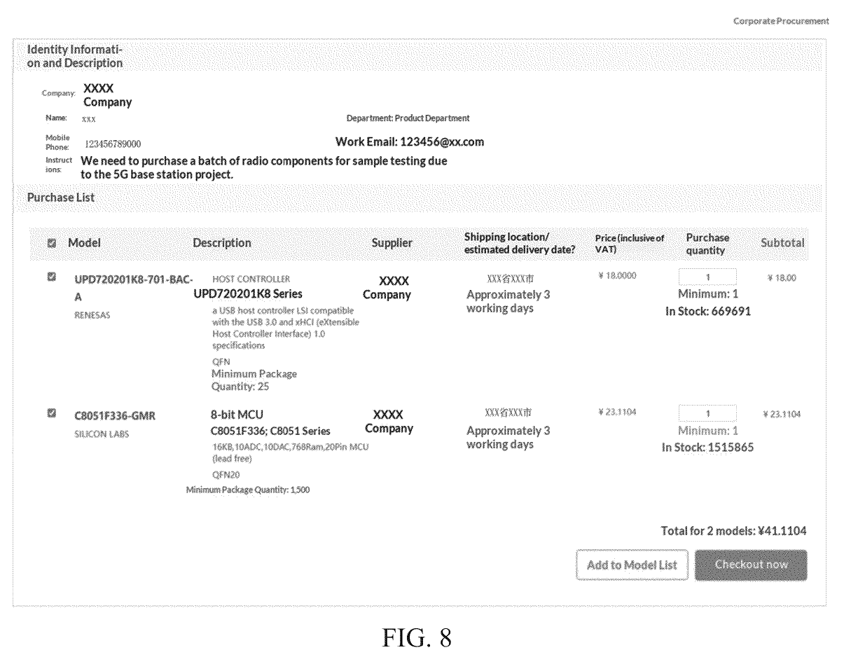

Specifically, in this embodiment, the client can push the procurement list to the corresponding mobile phone number and work email (i.e., the mobile phone, tablet, or computer used by the procurement officer, determined by the mobile phone number and work email) based on the procurement officer's mobile phone number and work email in the procurement list. After receiving the procurement list, the procurement officer can access the e-commerce platform via a link in an email or SMS (as shown in FIG. 7) to view the enterprise procurement information submitted by the engineer (as shown in FIG. 8). After confirming the engineer-submitted enterprise procurement information, the procurement officer directly places an order based on the product demand list (as shown in FIG. 6).
Step S105: The terminal sends a procurement order to the server based on the enterprise procurement information.
Step S106: The server receives the procurement order and returns an order confirmation message to the client based on the procurement order.

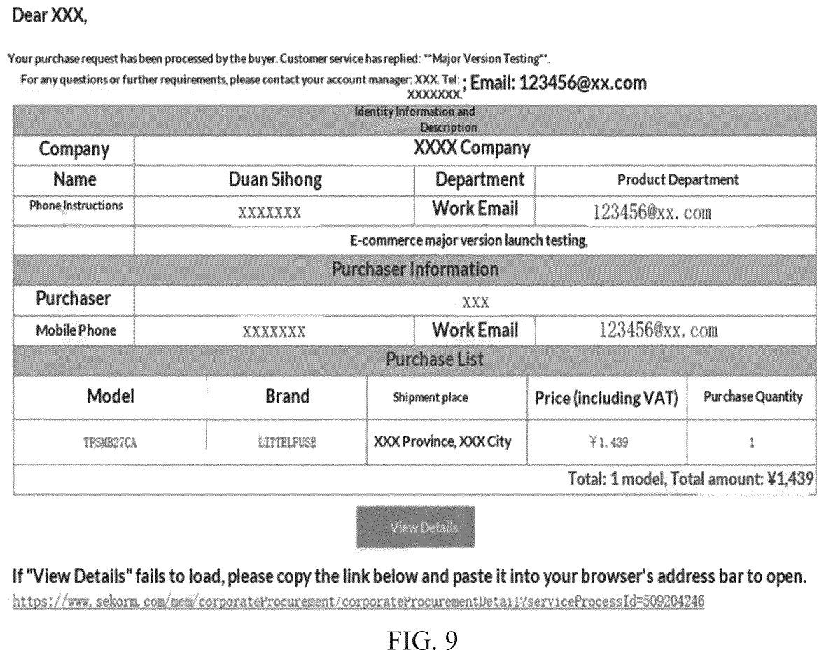

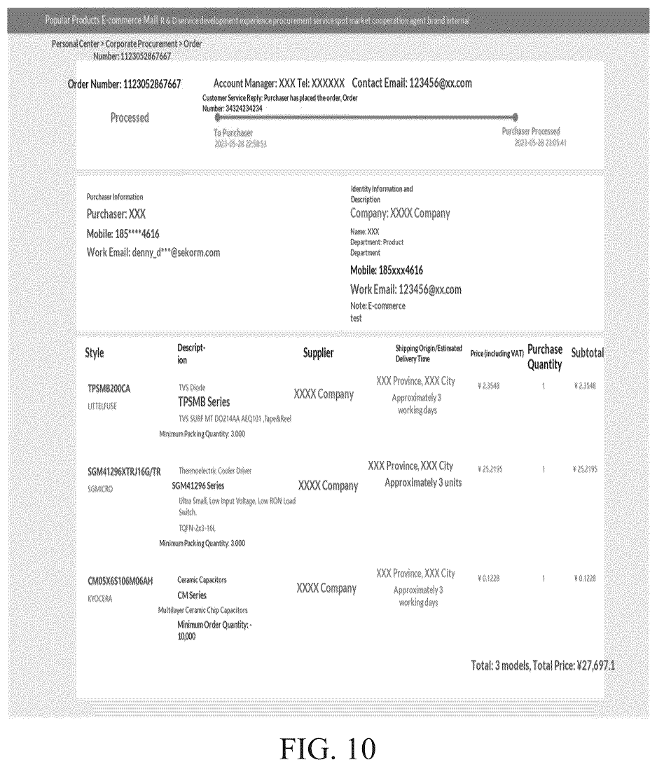

As shown in FIG. 9 and FIG. 10, after receiving the procurement order, the server (service provider platform) returns an order confirmation message to the client. Upon receiving this information, the client displays it to the engineer to confirm the successful order placement.

Furthermore, in this embodiment, the method for sharing product information based on enterprise procurement also comprises: after the client sends the procurement list to a terminal, generating an enterprise procurement service order.

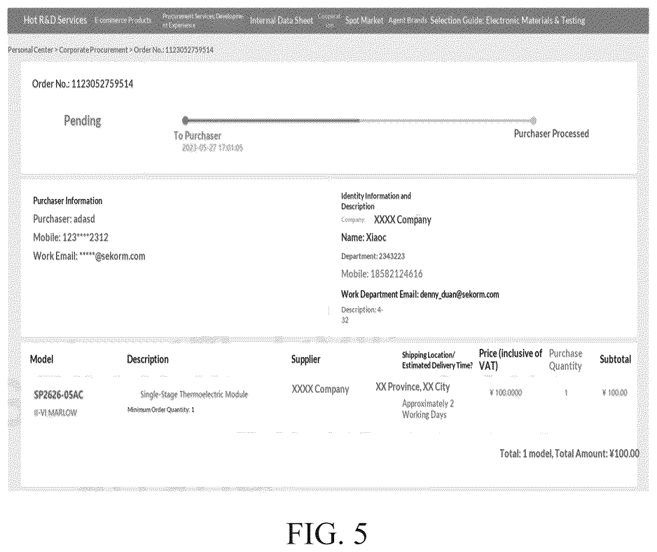

Specifically, after the client sends the procurement list to the procurement officer, the client automatically generates an enterprise procurement service order. As shown in FIG. 5, the engineer can track the specific status of this order to determine whether the procurement officer has placed the order and whether they have contacted the account manager from the service provider platform assigned to this service.

Additionally, in this embodiment, the method for sharing product information based on enterprise procurement further comprises: the e-commerce platform generates a service order to allow the account manager, using the information of the procurement officer within the order, to assist the procurement officer with relevant operations for the procurement order.

The present invention also provides a system for sharing product information based on enterprise procurement, comprising: a client and a terminal.

The client is configured to: receive product information of a product to be procured input by a user, and initiate an enterprise procurement service based on the product information; receive procurement information input by a user, and generate a procurement list based on the procurement information and the product information; send the procurement list to a terminal, and display an order confirmation message after receiving the order confirmation message returned by a server.

The terminal is configured to: receive the procurement list and obtain enterprise procurement information based on the procurement list; send a procurement order to the server based on the enterprise procurement information.

Further, in this embodiment, the system for sharing product information for enterprise procurement further comprises: a server; the server receives the procurement order and returns the order confirmation message to the client based on the procurement order.

In this embodiment, the product information comprises: the name of the product to be procured and the quantity of the product to be procured; the procurement information comprises: information of a procurement officer and information of an engineer; the information of the procurement officer comprises: the name and contact details of the procurement officer; the information of the engineer comprises: the name of the company where the engineer works, the department of the engineer, the name of the engineer, and the contact details of the engineer.

Further, in this embodiment, the client is specifically configured to: receive the information of the procurement officer and the information of the engineer input by a user; add the information of the procurement officer and the information of the engineer to the product information to generate the procurement list.

Further, the client is also configured to: receive a procurement information confirmation operation instruction input by a user; output and display a procurement list based on the procurement information confirmation operation instruction; determine whether a confirmation instruction input by a user is received; and if so, send the procurement list to the terminal.

Specifically, the detailed collaborative operation process among the client, terminal, and server in the system for sharing product information based on enterprise procurement can be referred to the method for sharing product information based on enterprise procurement, which will not be repeated here.

The present invention, by enabling engineers to share procurement product information for procurement officer to directly place orders, achieves the following beneficial effects:
The procurement officer can promptly obtain and understand engineers'procurement requirements, quickly completing procurement tasks without repeated inquiries to confirm needs, thereby reducing communication costs and time delays in the procurement process and effectively improving the enterprise's product development efficiency. Procurement officer can review detailed product information, procurement quantities, and technical specifications provided by engineers, minimizing procurement errors caused by inaccurate understanding of requirements, avoiding unnecessary rework or material waste, and reducing procurement costs. The procurement information is presented in a platform form between engineers and procurement officers, preventing information omissions or misunderstandings arising from phone or email communication, effectively overcoming interdepartmental communication barriers and improving internal collaboration. Relevant procurement information, such as supplier lists, price ranges, and delivery time references, can be shared on the platform, avoiding information silos in R&D or procurement processes, providing reference value for other project teams, and facilitating the effective integration and utilization of enterprise resources.

Additionally, this “engineer sharing—procurement officer ordering” workflow can serve as a standardized collaboration model between internal R&D and procurement departments. Long-term implementation can cultivate employee habits and mindsets, establishing closer collaborative relationships and contributing to the standardization and management of enterprise operations.

Therefore, the present invention can generate substantial benefits in multiple aspects, such as improving R&D efficiency, reducing procurement costs, minimizing procurement errors, enhancing internal communication, and facilitating information sharing. It also contributes to the optimization of internal management and collaboration models within enterprises, aligning with the needs of digital transformation and collaborative development.

The various embodiments in this specification are described in a progressive manner, with each embodiment focusing on differences from other embodiments. Identical or similar parts across embodiments can be referenced mutually. As for the devices disclosed in the embodiments, since they correspond to the methods disclosed, their descriptions are relatively brief, and relevant details can be found in the method sections.

Professionals may further recognize that the units and algorithm steps described in the examples disclosed in the embodiments can be implemented using electronic hardware, computer software, or a combination of both. To clearly illustrate the interchangeability of hardware and software, the composition and steps of each example have been generally described in terms of functionality in the foregoing description. Whether these functions are executed by hardware or software depends on the specific application and design constraints of the technical solution. Professionals may use different methods for each specific application to achieve the described functionality, but such implementations should not be considered beyond the scope of the present invention.

The steps of the methods or algorithms described in the embodiments disclosed herein can be directly implemented using hardware, software modules executed by a processor, or a combination of both. Software modules may reside in random-access memory (RAM), internal memory, read-only memory (ROM), electrically programmable ROM (EPROM), electrically erasable programmable ROM (EEPROM), registers, hard disks, removable disks, CD-ROMs, or any other form of storage medium known in the technical field.

The above embodiments are intended solely to illustrate the technical concepts and features of the present invention, enabling those skilled in the art to understand its content and implement it accordingly. They should not be construed as limiting the scope of protection of the invention. Any equivalent modifications or variations made within the scope of the claims of the present invention shall fall within the coverage of the claims.

What is claimed is:

1. A method for sharing product information based on enterprise procurement, wherein comprising the following steps:
a client receives product information of a product to be procured input by a user and initiates an enterprise procurement service based on the product information;
the client receives procurement information input by a user and generates a procurement list based on the procurement information and the product information;
the client sends the procurement list to a terminal;
the terminal receives the procurement list and obtains enterprise procurement information based on the procurement list;
the terminal sends a procurement order to a server based on the enterprise procurement information;
the server receives the procurement order and returns an order confirmation message to the client based on the procurement order.

2. The method for sharing product information based on enterprise procurement according to claim 1, wherein:
the product information comprises: the name of the product to be procured and the quantity of the product to be procured;
the procurement information comprises: the information of the procurement officer and the information of the engineer;
the information of the procurement officer comprises: the name and contact details of the procurement officer;
the information of the engineer comprises: the name of the company where the engineer works, the department of the engineer, the name of the engineer, and the contact details of the engineer.

3. The method for sharing product information based on enterprise procurement according to claim 2, wherein, the step of the client receives the procurement information input by a user and generates the procurement list based on the procurement information and the product information comprises:
the client receives the information of the procurement officer and the information of the engineer input by a user;
adding the information of the procurement officer and the information of the engineer to the product information to generate the procurement list.

4. The method for sharing product information based on enterprise procurement according to claim 1, wherein, before the step of the client sends the procurement list to the terminal, the method comprises:
the client receives a procurement information confirmation operation instruction input by a user;
the client outputs and displays the procurement list based on the procurement information confirmation operation instruction;
the client determines whether a confirmation instruction input by a user is received;
if yes, the client sends the procurement list to the terminal.

5. The method for sharing product information based on enterprise procurement according to claim 1, wherein the method further comprises:
after the client sends the procurement list to the terminal, generates an enterprise procurement service order.

6. A system for sharing product information based on enterprise procurement, wherein the system comprises a client and a terminal;
the client is configured to: receive product information of a product to be procured input by a user, and initiate an enterprise procurement service based on the product information;
receive procurement information input by a user, and generate a procurement list based on the procurement information and the product information;
send the procurement list to a terminal, and display an order confirmation message after receiving the order confirmation message returned by a server;
the terminal is configured to: receive the procurement list and obtain enterprise procurement information based on the procurement list;
send a procurement order to a server based on the enterprise procurement information.

7. The system for sharing product information based on enterprise procurement according to claim 6, wherein, the system further comprising: a server;
the server receives the procurement order and returns the order confirmation message to the client based on the procurement order.

8. The system for sharing product information based on enterprise procurement according to claim 6, wherein, the product information comprises: the name of the product to be procured and the quantity of the product to be procured;
the procurement information comprises: the information of the procurement officer and the information of the engineer;
the information of the procurement officer comprises: the name and contact details of the procurement officer;
the information of the engineer comprises: the name of the company where the engineer works, the department of the engineer, the name of the engineer, and the contact details of the engineer.

9. The system for sharing product information based on enterprise procurement according to claim 8, wherein, the client is specifically configured to:
receive the information of the procurement officer and the information of the engineer input by a user;
add the information of the procurement officer and the information of the engineer to the product information to generate a procurement list.

10. The system for sharing product information based on enterprise procurement according to claim 6, wherein, the client is further configured to:
receive a procurement information confirmation operation instruction input by a user;
output and display the procurement list based on the procurement information confirmation operation instruction;
determine whether a confirmation instruction input by a user is received;
if yes, send the procurement list to a terminal.
